(19) United States
(12) Patent Application Publication
(10) Pub. No.: US 2007/0036168 A1
(43) Pub. Date: Feb. 15, 2007

(54) CONTROLLER AND METHOD FOR PER-FLOW RATE

(76) Inventors: Yi-Lung Hsiao, Hsin-Chu (TW); Fu-Hsiung Chiu, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,159

(22) Filed: Jan. 26, 2006

(30) Foreign Application Priority Data
Aug. 11, 2005 (TW) 94127278

(51) Int. Cl. H04L 12/56

(52) U.S. Cl. 370/412

(57) ABSTRACT

A per-flow rate controller is disclosed. The controller includes a queue classifying unit, a queue memory unit and a queue selecting unit. The queue classifying unit receives a plurality of per-flows and then classifies them by the source port address of each per-flow group. The queue memory unit includes a plurality of queues. The queue memory unit stores the packets into corresponding queues according to the classifying result of the queue classifying unit. Finally, the queue selecting unit selects the queue for frame transmission and controls the output throughput rate of each queue according to user settings.

### CROSS-REFERENCE TO RELATED APPLICATION

This application claims the priority benefit of Taiwan application serial no. 94127278, filed on Aug. 11, 2005. All disclosure of the Taiwan application is incorporated herein by reference.

### BACKGROUND OF THE INVENTION

1. Field of Invention

The present invention relates to a per-flow rate controller. More specifically, the present invention relates to a per-flow rate controller and the control method thereof, which controls the per-flow transmitting rate according to the per-flow transmitting path.

2. Description of Related Art

In recent years, since the hardware price of personal computer (PC) has become cheaper and cheaper and the supporting software tends to be more diverse, the PC popularity has been increased considerably. Besides the general data processing, the video, audio and image processing functions of PC are also enhanced gradually. This indicates that the multimedia era has begun. Generally speaking, the functions of the present multi-media PC are complete and independent, which enable a user to complete most of the tasks on such PCs.

However, from the viewpoint of resources sharing, it is essentially important to optimize the functions of computers by linking many computers (including PCs) by a local area network (LAN), so that the resources (hardware or software) can be shared between computers. On a computer network, a computer program can be executed on another computer and sending the result back after the execution by distributed process. Sometimes files or data can also be shared via the computer network.

From the viewpoint of Internet, a user can link to various web sites all over the world through the internet to access the related information. Recently, the prevalence of World Wide Web (WWW) not only increases the internet user population, but also greatly improves the speed of resource or information exchange.

A computer network should have a set of network operating system which is used to manage the hardware (such as computer itself, printers, plotters or communication devices) and software resources (such as video, audio, programs, files and data, etc.) on the network, so that the integrated functions of the computer network can be fully exploited. The network operating system also needs to provide a friendly and convenient interface to the users, so that the users can use various resources on the network without knowing where these resources are located by communicating with the network operating system. Moreover, the network operating system can also coexist with the PC operating system. Usually, the users only use PC operating system to complete various tasks, and use the network operating system to communicate with other computers when needed.

To be prepared for the incoming multi-media age, the hardware and software of PCs and workstations have been developed significantly. With the popularity of the multi-media computers, it gradually becomes difficult for the conventional LAN to handle the multi-media communications which require relatively higher service quality. For example, the video and audio require real-time transmission function so as to be played on the receiving end in time. Furthermore, reading images or video/audio from WWW requires a relatively large bandwidth. Therefore, how to completely transmit the important and real-time data at a fast speed with the use of a limited bandwidth becomes a very important research.

Currently, in the network system, whether the packet is processed with a priority depends on whether the being-transmitted packet is flagged with a priority flag. For example, the priority flags of video and audio data which need to be real-time transmitted are set to the highest priority so as to avoid any delay of the video and audio data transmission. So that, the Quality of Service is introduced to ensure the condition and reliability of services. Quality of Service (QoS) refers to the capability of a network to provide better service which goal is to provide priority including dedicated bandwidth, latency and jitter. However, in the current network system, besides determining the packet processing sequence according to whether the priority flag is set, other features of the packet can not be used to determine the packet processing sequence. For example, in the network, the source address of the packet can not be used to determine whether the packet transmitting time needs to be increased. As for more and more diversified packet data, it is not enough to determine the packet processing priority sequence only based on the priority flag.

### SUMMARY OF THE INVENTION

The object of the present invention is to provide a per-flow rate controller which can determine the output throughput rate of each queue according to the transmitting path of per-flow group. In the traditional bandwidth control method, the traffic throughput rate only can set or limit the rate at ingress or egress port, but not for an ingress to egress port pair.

Another object of the present invention is to provide a per-flow rate control method. This method first performs traffic classification according to the priority of incoming frame; then determines the traffic throughput rate of each queue according to the transmitting path of each of per-flow group.

The present invention provides a per-flow rate controller, including a queue classifying unit, a queue memory unit and a queue selecting unit. Wherein, the queue classifying unit performs the classification job according to the pre-set per-flow group which defined in the classification mapping table. The queue memory unit including a plurality of queues to store packets into corresponding queues according to the classification results from the queue classifying unit. The queue selecting unit performs the queue scheduling job and determines which queue can transmit packet during a specific time period when the pre-set bandwidth is reached.

According to the embodiment of the present invention, in the above-mentioned per-flow rate controller, the queue classifying unit includes a per-flow priority checking circuit and a queue classifying logic. Wherein, the per-flow priority checking circuit determines the transmit priority of the received frame according to the pre-set per-flow priority. And the queue classifying logic classifies the received frame and gives an index to the queue memory unit to tell where is destination queue should the received frame stay.

According to the embodiment of the present invention, the above per-flow path is from a source address to a destination address or from a source port to a destination port. According to the embodiment of the present invention, the above queue selecting unit includes a frame transmit scheduling control circuit and a queue selecting circuit. Wherein, the frame transmit scheduling control circuit generates a control signal according to the priority weight by user settings. This control signal is an indicator to tell the queue selecting circuit for which frame should transmit first. The queue selecting circuit is coupled with the queue memory unit, which determines the transmission rate of each per-flow group and switch the transmission token between these priority queues.

According to the embodiment of the present invention, the above frame transmitting control circuit further has a bandwidth mapping table used to record the transmission bandwidth of each per-flow queue in the queue memory unit.

According to the embodiment of the present invention, each of the above per-flow group, at least, includes a source address or port information, a destination address or port information, frame information, a frame priority weight and a status code.

The present invention further provides a per-flow rate control method. This per-flow rate control method first classify the incoming frames and store it into the different queue based on the per-flow priority weight; and then the queue selecting circuit according to the transmission bandwidth rate to select the queue for frame transmission. The higher priority queue has a higher privilege to transmit frame; once the outgoing frame reached the pre-set per-flow bandwidth, the queue scheduling logic will switch to the next priority queue. The queue scheduling logic determines which queue can transmit frame according to the per-flow bandwidth setting.

According to the embodiment of the present invention, the per-flow transmitting path is from a source address to a destination address or from a source port to a destination port.

According to the embodiment of the present invention, the above frame transmitting control circuit further has a traffic rate table which is used to record and monitor the frame transmitting rate status of each per-flow group. The control method of the per-flow rate controls the frame transmitting time or bandwidth of each per-flow group according to the above traffic rate table.

According to the embodiment of the present invention, each above-mentioned per-flow queue at least includes a source port address information, a destination port address information, frame information, priority weight and a status code.

Since the method of bandwidth control is used in the present invention, therefore the transmitting rate on a specific transmitting port can be thus controlled. Users can assign different transmitting rate according to the data type between the source and destination pair. Therefore, without changing the network bandwidth seeting or topology, the relatively important data can use more bandwidth and the less significant data use less bandwidth. Thus, the efficiency and the performance of the whole network can be increased.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

FIG. 1 schematically illustrates the circuit block diagram of a per-flow rate controller according to the present invention.

FIG. 2 schematically illustrates the interior circuit block diagram of the queue classifying unit in a per-flow rate controller according to the present invention.

FIG. 3 schematically illustrates the interior circuit block diagram of the queue selecting unit in a per-flow rate controller according to the present invention.

FIG. 4 schematically illustrates the diagram of the per-flow rate control between the different transmitting paths according to the present invention.

FIG. 5 schematically illustrates the flow chart of the control method of a per-flow rate controller according to the present invention.

### DESCRIPTION OF EMBODIMENTS

The most significant feature of the per-flow rate controller and the control method thereof provided in the present invention is that the transmitting rate between different source destination pair can be set, so that the efficiency and performance of the whole network can be effectively increased without changing the original bandwidth setting or topology of the network.

FIG. 1 schematically illustrates the circuit block diagram of a per-flow rate controller according to the present invention. As shown in FIG. 1, the per-flow rate controller includes a queue classifying unit 101, a queue memory unit 103 and a queue selecting unit 105. The queue classifying unit 101 is used to receive the incoming frame and proceed with the frame classification job. The video, the audio, the image and other data can be classified into different queue in the above-mentioned per-flow group according to their data type.

Generally, the per-flow queues are assigned to different priorities according to the nature of the frame contents or the port priority. For example, the video information is considered to be real-time transmitted so that the priority of the video information is higher than the other information. In the embodiment of the present invention, the priority classification of the above queue classifying unit 101 is performed according to the source/destination address or port of the per-flow group.

In addition, the queue memory unit 103 has a plurality of queues 107. The queue memory unit 103 stores the packets in queue according to the classifying results from the queue classifying unit 101. Finally, the queue selecting unit 105 is the output queue selector logic of the per-flow rate controller. The queue selecting unit 105 performs the queue selecting and scheduling job and selects the frame transmission path between the queue memory unit 103. The queues in the frame transmit sequence is arranged from the higher priority queue to the lower priority queue. Once the user pre-defined bandwidth is reached, the queue selecting unit 105 will switch the transmit queue index to the next lower priority queue.

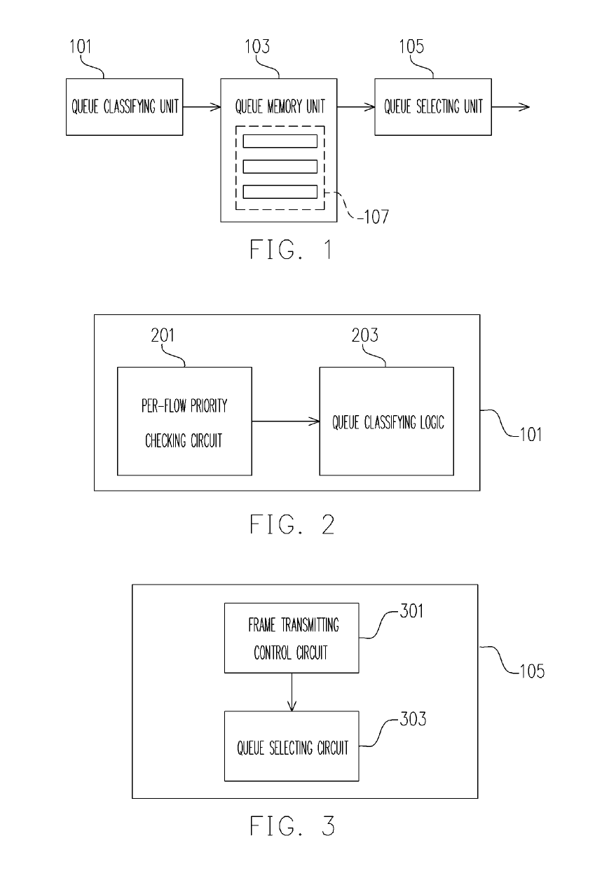

FIG. 2 schematically illustrates the interior circuit block diagram of the above queue classifying unit 101 in a per-flow rate controller according to the present invention. As shown in FIG. 2, the queue classifying unit 101 includes a per-flow priority checking circuit 201 and a queue classifying logic 203.

The per-flow priority checking circuit 201 is used to classify the received frame priority of each per-flow described above. In the present embodiment, the per-flow path includes the pair of the source address or port and destination address or port. The priority checking circuit 201 determines the transmit priority sequence according to the user defined priority table. Moreover, the queue classifying logic 203 is coupled to the per-flow priority checking circuit 201 and stores the frame after classified into the memory queues of queue memory unit 103 according to the checking result of the priority checking circuit 201.

FIG. 3 schematically illustrates the interior circuit block diagram of the above queue selecting unit 105 in a per-flow rate controller according to the present invention. As shown in FIG. 3, the queue selecting unit 105 includes a frame transmitting control circuit 301 and a queue selecting circuit 303. The frame transmitting control circuit 301 generates a bandwidth control signal according to the user settings. The queue selecting circuit 303 determines the time of frame transmission period of each per-flow queue group according to the bandwidth control signal, and thus further controls the per-flow rate of each of per-flow group.

At least, the source port address information, destination port address information, frame information, priority weight and a status code are included in the per-flow group. As described, the queue selecting unit 105 arranges and determines the transmitting time and output throughput rate of each queue according to the output port address of each queue stored in the queue memory unit 103. In addition, the frame transmitting control circuit 301 further includes a traffic throughput control logic used to monitor the transmitting rate of each output queue in the queue memory unit 103.

The queue selecting circuit 303 in the queue selecting unit 105 will select and transmit the frame which is stored in the queue memory unit 103 according to the queue information and status from the frame transmit control unit 301. Once the higher priority queue is empty or reached the pre-defined bandwidth, the queue selecting circuit 303 will switch the transmitting index to next priority queue automatically. Thus, the output throughput rate of each queue can be controlled so that bandwidth resources can be shared between the different queues.

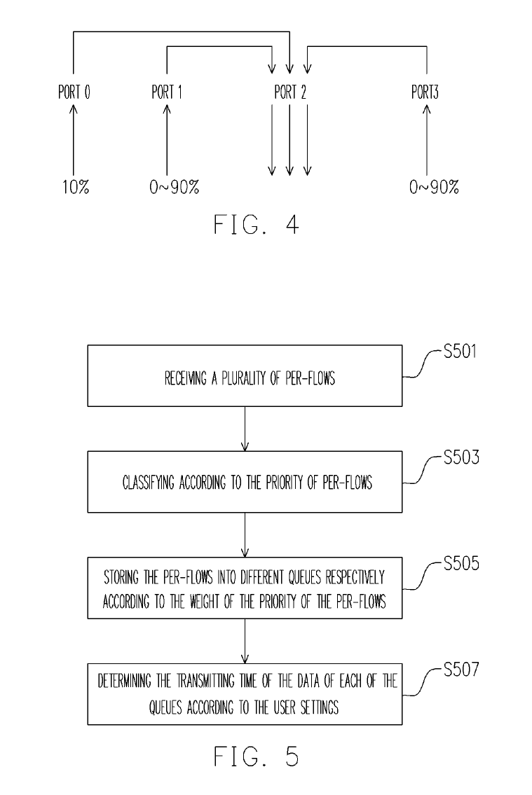

FIG. 4 schematically illustrates the diagram of the per-flow rate control concept between the source and destination path which by the present invention. As shown in FIG. 4, a four-port switch is used as the example in the present embodiment. Practically, the per-flow rate controller provided in the present invention can be used on the structures with different number of ports switch by those who are skilled in the art.

As shown in FIG. 4, after being processed by the queue classifying unit 101 and the queue memory unit 103 and the queue selecting unit 105, it will have three per-flow rate control path in total to be processed and the transmitting paths thereof are port 0, 1 and 3 to port 2. Port 0 is the per-flow source port and the port 2 is the per-flow destination port, the path from port 0 to port 2 forms a per-flow path. The traffic throughput control logic in the frame transmitting control circuit 301 can assign different rates according to different transmitting paths.

In the present embodiment, if it is known that the frames transmitted between the source port 0 to the destination port 2 are more important or needed to be real-time transmitted, a fixed amount of bandwidth is reserved for the frames transmitted between the source port 0 to the destination port 2 first by setting the reservation in the traffic throughput control table in the frame transmitting control circuit 301.

For example, in the present embodiment, the total output throughput of port 2 is 100%. With reference to FIG. 4, a 10% of the bandwidth can be reserved for the path from source port 0 to destination port 2 and the other paths to port 2 shares the rest 90% of the bandwidth. Thus, because a fixed amount of bandwidth is reserved for the path between port 0 and port 2, the frame transmission rate between the source port 0 to the destination port 2 can be guaranteed.

In addition, in the present invention, a method of limiting a minimum amount of bandwidth can also be used to set per-flow rates between a specific source port-destination port pair. This method is described by using the same embodiment mentioned above. As the settings in the above embodiment, 10% of the bandwidth is reserved from the source port 0 to destination port 2, and the other traffic path from port 1 and 3 to port 2 shares the rest of 90% bandwidth rate in maximum.

Assuming the frame data transmitted to the destination port 2 from the source port 1 and port 3 only accounts for 70% of the total bandwidth. Therefore, 20% of the bandwidth is still unused and the traffic from port 0 to port 2 occupies at least 10% of bandwidth. At this time, the queue selecting circuit 303 in the queue selecting unit 105 can automatically perform bandwidth regulation to assign the rest unused 20% of the bandwidth to the per-flow transmitting path from the source port 0 to the destination port 2. Hence, the throughput from source port 0 to the destination port 2 can be improved to 30% and the whole network efficiency can be effectively increased.

FIG. 5 schematically illustrates the flow chart of the control method of a per-flow rate controller according to the present invention. The flow chart is described below in conjunction with the embodiment disclosed in FIG. 1. As shown in FIG. 5, in the step S501, a plurality of frames are received. That is, the queue classifying unit 101 in FIG. 1 is used to receive the incoming frames and classify the incoming frames into the different per-flow groups.

Next, in the step S503, the received frames are priority classified according to the per-flow group definition which defines in the traffic throughput control logic. That is, as shown in FIG. 1, the priority classification is performed by using the per-flow priority checking circuit 201 in the queue classifying unit 101 in FIG. 1. Next, in the step S505, when the priority checking is finished, each frame described in above is stored into different queues respectively according to the priority weight of each per-flow group. That is, as shown in FIG. 1, the incoming frames are stored into different queue in the queue memory unit 103 according to the result of priority checking, and the queue with a higher priority occupies more bandwidth for sending frames.

Finally, in the step S507, the traffic throughout rate of each per-flow group is determined according to the priority weight of each queue. Corresponding to the embodiment in FIG. 1, the operation in the step S507 equals to the operation in the queue selecting circuit 303 in the queue selecting unit 105. That is, the frame transmission channel is switched between queues in the queue memory unit 103. Meanwhile, the traffic throughput control logic in the frame transmitting control circuit 301 monitors and reports the status of each queue according to the setting in the bandwidth table. Thus, the output throughput rate of each queue can be controlled. As a result, the queue with a higher priority can occupy more bandwidth resource to send frames so as to complete the frame transmission more quickly than that of the lower priority queue.

Altogether, according to the per-flow rate controller and the control method thereof provided by the present invention, not only the processing sequence can be determined according to the priority setting of each queue but also the transmitting rate between specific source port to another destination port can be controlled. Therefore, the user can assign different traffic throughput rates according to the application need to transmit between the switch ports. Thus, without changing the network topology, the per-flow source port can use more bandwidth than others. The overall efficiency of the network can be effectively improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A per-flow rate controller, comprising:
a queue classifying unit, receiving a plurality of frames through a plurality of per-flow paths and classifying the frames according to a source port address or port number of each per-flow path;
a queue memory unit, comprising a plurality of queues, and storing the frames into each queue according to a classifying result of the queue classifying unit; and
a queue selecting unit, selecting the transmitting index between queues, and determining the traffic output throughput rate of each of queue according to the traffic throughput control table so as to control the transmitting rate of each per-flow path.

2. The per-flow rate controller of claim 1, wherein the queue classifying unit comprises:
a per-flow priority checking circuit, performing a priority check according to the source address or port of each per-flow path; and
a queue classifying logic, coupled to the per-flow priority checking circuit, storing the packets into the corresponding queues respectively according to a result of the priority check performed by the per-flow priority checking circuit.

3. The per-flow rate controller of claim 1, wherein the frames are transmitted from a source address to a destination address.

4. The per-flow rate controller of claim 1, wherein the frames are transmitted from a source port to a destination port.

5. The per-flow rate controller of claim 1, wherein the queue selecting unit comprises:
a frame transmitting control circuit, generating a control signal according to user settings; and
a queue selecting circuit, coupled to the queues, and determining a throughput rate of each output queue according to the control signals, so as to control the output throughput rate of each per-flow path.

6. The per-flow rate controller of claim 5, wherein the frame transmitting control circuit further comprises a traffic throughput control table which is used to monitor the throughput rate of each queue in the queue memory unit.

7. The per-flow rate controller of claim 1, wherein the format of each of the per-flow path comprises at least a source port address information, a destination port address information, a frame information, a frame priority weight and a status code.

8. A per-flow rate control method, comprising:
receiving a plurality of frames through a plurality of per-flow paths;
classifying the frames according to a source port address of each per-flow path;
storing the frames into queues respectively according to a weight of a priority of each per-flow path; and
transmitting the frames stored in each of the queues, and determining an output throughput rate of the frames of each queue according to the user settings.

9. The per-flow rate control method of claim 8, wherein the frames are transmitted from a source address to a destination address.

10. The per-flow rate control method of claim 8, wherein the frames are transmitted from a source port to a destination port.

11. The per-flow rate control method of claim 8 further comprising a step of monitoring the throughput rate of each per-flow path by using a traffic throughput control table.

12. The per-flow rate control method of claim 11, wherein the per-flow rate control method controls the output throughput rate of each of the per-flow path according to the traffic throughput control table.

13. The per-flow rate controller of claim 9, wherein the format of each per-flow path comprises at least a source port address information, a destination port address information, a frame information, a frame priority weight and a status code.
